(19) United States
(12) Patent Application Publication
(10) Pub. No.: US 2020/0230718 A1
(43) Pub. Date: Jul. 23, 2020

(54) CIRCULAR SAW

(71) Applicant: Nanjing Chervon Industry Co., Ltd., Nanjing (CN)

(72) Inventors: Xiaogang Ding, Nanjing (CN); Junya Duan, Nanjing (CN); Tiantian Yin, Nanjing (CN); Huilong Zhou, Nanjing (CN)

(21) Appl. No.: 16/791,033

(22) Filed: Feb. 14, 2020

Related U.S. Application Data
(63) Continuation of application No. PCT/CN2018/094907, filed on Jul. 6, 2018.

(30) Foreign Application Priority Data
Aug. 18, 2017 (CN) 201710709777.9
Mar. 28, 2018 (CN) 201810265661.5

(51) Int. Cl. B23D 45/16

(52) U.S. Cl. CPC B23D 45/16

(57) ABSTRACT

A circular saw includes a control unit having a signal processing unit. The signal processing unit is configured to collect a bus current and/or a phase current of the motor and output a second drive signal to the drive circuit after the bus current and/or the phase current of the motor is processed by the signal processing unit, so that the motor charges a battery pack with a charging current less than or equal to 50 A. A control method may independently adjust the current of the motor in the circular saw by optimizing the processing for the phase current and/or the bus current of the motor and feed back electric energy generated by the motor to the power supply to optimize the utilization efficiency of the power supply.

### RELATED APPLICATION INFORMATION

This application claims the benefit of International Application Number PCT/CN2018/094907, filed on Jul. 6, 2018, through which this application claims the benefit of Chinese Patent Application No. 201710709777.9, filed on Aug. 18, 2017, the disclosures of which are incorporated herein by reference in their entirety.

### TECHNICAL FIELD

The present disclosure relates to the technical field of power tools, and in particular, a circular saw.

### BACKGROUND

For an existing circular saw, a drive circuit is powered by a power supply, and a motor is driven by the drive circuit. However, at present, power is unidirectionally supplied to the drive circuit from the power supply, and power utilization efficiency is not high. Power utilization efficiency refers to an efficiency with which the power output by the power supply is converted into mechanical energy. Corresponding to the circular saw, the power utilization efficiency refers to a number of cuttings of the circular saw, which may be evaluated by a number of cuttings per watt-hour. At present, a power reserve per watt-hour of the power supply may only afford the circular saw 0.8 cuttings, and the power utilization efficiency is not high.

### SUMMARY

In order to solve the shortcomings of the related art, an object of the present disclosure is to provide a circular saw. By controlling a motor, in particular, by precise and independent control of current in the motor, the optimization of the performance of the circular saw and the improvement of power utilization efficiency are achieved.

To achieve the above-mentioned object, the present disclosure adopts the following technical solutions.

The present disclosure first provides a circular saw, including: a bottom plate; a housing, mounted on the bottom plate; a saw blade cover, connected to the housing; a saw blade shaft, configured for supporting a saw blade in the saw blade cover; a brushless motor, disposed in the housing and including a stator and a rotor; a motor shaft, driven by the rotor of the brushless motor; a transmission device, configured to connect the motor shaft and the saw blade shaft, where the transmission device includes a worm wheel and a worm that are meshed with each other; a drive circuit, including a switching circuit for outputting a first drive signal to control the rotor of the brushless motor to operate; a switching device, disposed on an outer surface of the housing and configured to generate a switching signal in response to an operation of a user on the circular saw; a control unit, including one or one group of controllers for driving the brushless motor according to the first drive signal generated by the drive circuit; and a battery pack, for supplying power to the brushless motor, the drive circuit, and the control unit. The control unit or the controller includes a signal processing unit, the signal processing unit is configured to collect a bus current and/or a phase current of the brushless motor, and output a second drive signal to the drive circuit after the bus current and/or the phase current of the brushless motor being processed by the signal processing unit, so that the brushless motor charges the battery pack with a charging current less than or equal to 50 A.

In one example, in the circular saw, the control unit further includes a position estimation unit that is electrically connected to a phase line of the motor and obtains a position of the rotor of the brushless motor according to a terminal voltage and/or a current on a phase line of the brushless motor and outputs the position of the rotor to the signal processing unit. The signal processing unit generates the second drive signal to drive the rotor of the brushless motor, and the second drive signal is generated according to the position of the rotor of the brushless motor.

In one example, in the circular saw, a position sensor is further provided adjacent to the brushless motor, the control unit or the controller is further electrically connected to the position sensor, and configured to obtain a position of the rotor of the brushless motor according to a signal of the position sensor, and the second drive signal is generated according to the position of the rotor of the brushless motor.

In one example, in the circular saw, the signal processing unit processing the phase current and/or the bus current of the motor includes: according to the phase current and/or the bus current of the motor, generating the second drive signal to drive the motor according to the obtained position of the rotor of the motor so as to control the motor to output a sinusoidal current; in one example, the signal processing unit processing the phase current and/or the bus current of the motor includes: in response to the signal of the switching device and/or working data of the battery pack, according to the phase current and/or the bus current of the motor, generating the second drive signal according to the position of the rotor of the motor to drive the motor, so as to control the motor to output the sinusoidal current. An amplitude and/or a direction of the sinusoidal current may be adjusted by the second drive signal. And the working data of the battery pack includes the output current of the battery pack and/or the temperature of the battery pack; the signal of the switching device includes standby, shutdown, deceleration, or energy recovery.

In one example, the circular saw further includes a unidirectional conductive element. The switching device is connected between the drive circuit and the battery pack, the unidirectional conductive element is connected in parallel with the switching device, and a current flows from the drive circuit to the battery pack when the unidirectional conductive element is turned on.

In one example, the circular saw further includes a diode D1, configured for feeding back a current of the brushless motor to the battery pack via the diode D1.

In one example, the circular saw further includes a diode D1. The diode D1 is connected in parallel with the switching device, and is turned on when the switching device is in a switch-off state, so as to feed back a current output by the brushless motor to the battery pack via the diode D1.

In one example, in the circular saw, after being processed by the signal processing unit, the second drive signal is output to the drive circuit, so that the brushless motor charges the battery pack with a charging current within a range from 35 A to 50 A.

In one example, in the circular saw, after being processed by the signal processing unit, the second drive signal is output to the drive circuit, so that the brushless motor charges the battery pack with a charging current within a range from 20 A to 35 A.

In one example, in the circular saw, after being processed by the signal processing unit, the second drive signal is output to the drive circuit, so that the brushless motor charges the battery pack with a charging current within a range from 0 A to 20 A.

Simultaneously, the present disclosure further provides a circular saw, including: a brushless motor having a stator and a rotor; the rotor of the motor is connected to a motor shaft, where the motor shaft is driven by the rotor of the brushless motor; a saw blade shaft, configured for supporting the rotation of a saw blade to perform a cutting operation on a workpiece; a transmission device, configured for connecting the motor shaft to the saw blade shaft; a drive circuit, configured for output a first drive signal to control the rotor of the brushless motor to operate; a control unit, configured to drive the brushless motor based on the first drive signal generated by the drive circuit; and a power supply, configured to supply power to the brushless motor, the drive circuit, and the control unit. The control unit includes a signal processing unit. The signal processing unit is configured to collect a bus current and/or a phase current of the brushless motor, and output a second drive signal to the drive circuit after the bus current and/or the phase current of the brushless motor is processed by the signal processing unit, and the drive circuit is configured to control the brushless motor to output a sinusoidal current, so that the brushless motor charges the power supply with a charging current less than or equal to 50 A.

In one example, in the circular saw, the transmission device includes a worm wheel and a worm that are meshed with each other.

In one example, the circular saw further includes a unidirectional conductive element and a switching device. The switching device is connected between the drive circuit and the power supply, and configured to generate a switching signal in response to an operation of a user on the circular saw. And the unidirectional conductive element is connected in parallel with the switching device, and turned on when the switching device is in a switch-off state. And when the unidirectional conductive element is turned on, the sinusoidal current output by the motor is fed back to the power supply by the drive circuit.

In one example, the circular saw further includes a diode D1, configured for feeding back a current of the brushless motor to the power supply via the diode D1.

In one example, the circular saw further includes a diode D1 and a switching device. The switching device is connected between the drive circuit and the power supply, and configured to generate a switching signal in response to an operation of a user on the circular saw. And the diode D1 is connected in parallel with the switching device, and turned on when the switching device is in a switch-off state. And when the diode D1 is turned on, the sinusoidal current output by the brushless motor is fed back to the power supply by the drive circuit.

In one example, in the circular saw, after is processed by the signal processing unit, the second drive signal is output to the drive circuit, so that the brushless motor charges the power supply with a charging current within a range from 35 A to 50 A.

In one example, in the circular saw, after is processed by the signal processing unit, the second drive signal is output to the drive circuit, so that the brushless motor charges the power supply with a charging current within a range from 20 A to 35 A.

In one example, in the circular saw, after is processed by the signal processing unit, the second drive signal is output to the drive circuit, so that the brushless motor charges the power supply with a charging current within a range from 0 A to 20 A.

Simultaneously, the present disclosure further provides a circular saw, including: a motor having a stator and a rotor; and a transmission device, operatively coupled with the rotor to drive a saw blade of the circular saw so as to perform a cutting operation on a workpiece; a drive circuit, configured for outputting a first drive signal to control the rotor of the motor to operate; a switching device, configured for generating a switching signal in response to an operation on the circular saw; and a control unit, configured for generating a second drive signal to drive the motor in response to the switching signal of the switching device. The control unit includes a signal processing unit. The signal processing unit is configured to collect a bus current and/or a phase current of the motor, and output the second drive signal to the drive circuit after bus current and/or the phase current of the motor is processed by the signal processing unit, and the drive circuit is configured to control the motor to output a sinusoidal current, so that the motor charges the power supply of the circular saw with a charging current less than or equal to 50 A.

In one example, the circular saw further includes a feedback circuit, where the feedback circuit is configured to feed back a current of the motor to the power supply of the circular saw.

In one example, the circular saw further includes a diode D1, configured for feeding back the current of the motor to the power supply of the circular saw via the diode D1.

In one example, the circular saw further includes a unidirectional conductive element. In response to the unidirectional conductive element being turned on, a current output by the motor is fed back to the power supply of the circular saw through the unidirectional conductive element.

In one example, in the circular saw, the phase current and/or the bus current of the motor include any one or combination of the bus current of the motor, the phase current of the motor, and an inter-electrode current of a switching element on the switching circuit.

In one example, in the circular saw, the transmission device includes a worm wheel and a worm that are meshed with each other.

In one example, in the circular saw, after is processed by the signal processing unit, the second drive signal is output to the drive circuit, so that the motor charges the power supply of the circular saw with a charging current within a range from 35 A to 50 A.

In one example, in the circular saw, after is processed by the signal processing unit, the second drive signal is output to the drive circuit, so that the motor charges the power supply of the circular saw with a charging current within a range from 20 A to 35 A.

In one example, in the circular saw, after is processed by the signal processing unit, the second drive signal is output to the drive circuit, so that the motor charges the power supply of the circular saw with a charging current within a range from 0 A to 20 A.

In one example, the motor is configured to be a brushless direct current motor or a permanent magnet synchronous motor.

In one example, the transmission device may further include a deceleration structure. The deceleration structure may include gear structures with different gear ratios, or belt transmission structures with different pulley radii.

Simultaneously, the present disclosure further provides a circular saw, including: a bottom plate; a housing, mounted on the bottom plate; a saw blade cover, connected to the housing; a saw blade shaft, configured for supporting a saw blade in the saw blade cover; a brushless motor, disposed in the housing and including a stator and a rotor; a motor shaft, driven by the rotor of the brushless motor; a transmission device, configured to connect the motor shaft and the saw blade shaft, where the transmission device includes a worm wheel and a worm that are meshed with each other; a drive circuit, including a switching circuit for outputting a first drive signal to control the rotor of the brushless motor to operate; a switching device, disposed on an outer surface of the housing and configured to generate a switching signal in response to an operation of a user on the circular saw; a control unit, including one or one group of controllers for driving the brushless motor according to the first drive signal generated by the drive circuit; and a battery pack, for supplying power to the brushless motor, the drive circuit, and the control unit. The control unit or the controller includes a signal processing unit. The signal processing unit is configured to collect a bus current and/or a phase current of the brushless motor, and output a second drive signal to the drive circuit after the bus current and/or the phase current of the brushless motor is processed by the signal processing unit, so that the brushless motor drives the saw blade to operate in a cutting number of at least 0.9 cuttings per watt hour.

In one example, in the circular saw, the control unit further includes a position estimation unit that is electrically connected to a phase line of the motor and obtains a position of the rotor of the brushless motor by calculating according to a terminal voltage and/or a current on a phase line of the brushless motor and outputs the position to the signal processing unit. The signal processing unit generates the second drive signal to drive the rotor of the brushless motor, and the second drive signal is generated according to the position of the rotor of the brushless motor.

In one example, in the circular saw, a position sensor is further provided adjacent to the brushless motor, the control unit or the controller is further electrically connected to the position sensor, and configured to obtain a position of the rotor of the brushless motor according to a signal of the position sensor, and the second drive signal is generated according to the position of the rotor of the brushless motor.

In one example, in the circular saw, the signal processing unit processing the phase current and/or the bus current of the motor includes: according to the phase current and/or the bus current of the motor, generating the second drive signal to drive the motor according to the obtained position of the rotor of the motor so as to control the motor to output a sinusoidal current. In one example, the signal processing unit processing the phase current and/or the bus current of the motor includes: in response to the signal of the switching device and/or working data of the battery pack, according to the phase current and/or the bus current of the motor, generating the second drive signal according to the position of the rotor of the motor to drive the motor, so as to control the motor to output the sinusoidal current. An amplitude and/or a direction of the sinusoidal current may be adjusted by the second drive signal. And the working data of the battery pack includes the output current of the battery pack and/or the temperature of the battery pack; the signal of the switching device includes standby, shutdown, deceleration, or energy recovery.

In one example, the circular saw further includes a unidirectional conductive element. The switching device is connected between the drive circuit and the battery pack, the unidirectional conductive element is connected in parallel with the switching device, and a current flows from the drive circuit to the battery pack when the unidirectional conductive element is turned on.

In one example, the circular saw further includes a diode D1, configured for feeding back a current of the brushless motor to the battery pack via the diode D1.

In one example, the circular saw further includes a diode D1. The diode D1 is connected in parallel with the switching device, and turned on when the switching device is in a switch-off state, so as to feed back a current output by the brushless motor to the battery pack via the diode D1.

In one example, in the circular saw, after is processed by the signal processing unit, the second drive signal is output to the drive circuit, so that the brushless motor drives the saw blade to operate in a cutting number within a range from 0.9 to 1.0 cuttings per watt hour.

In one example, in the circular saw, after is processed by the signal processing unit, the second drive signal is output to the drive circuit, so that the brushless motor drives the saw blade to operate in a cutting number within a range from 1.0 to 1.2 cuttings per watt hour. In one example, in the circular saw, after is processed by the signal processing unit, the second drive signal is output to the drive circuit, so that the brushless motor drives the saw blade to operate in a cutting number within a range from 1.2 to 1.4 cuttings per watt hour.

In one example, in the circular saw, after is processed by the signal processing unit, the second drive signal is output to the drive circuit, so that the brushless motor drives the saw blade to operate in a cutting number within a range from 1.4 to 1.6 cuttings per watt hour.

Simultaneously, the present disclosure further provides a circular saw, including: a brushless motor having a stator and a rotor; a motor shaft, connected to the rotor of the motor and driven by the rotor of the brushless motor; a saw blade shaft, configured for supporting the rotation of a saw blade to perform a cutting operation on a workpiece; a transmission device, configured for connecting the motor shaft to the saw blade shaft; a drive circuit, configured for output a first drive signal to control the rotor of the brushless motor to operate; a control unit, configured to drive the brushless motor according to the first drive signal generated by the drive circuit; and a power supply, configured to supply power to the brushless motor, the drive circuit, and the control unit. The control unit includes a signal processing unit. The signal processing unit is configured to collect a bus current and/or a phase current of the brushless motor, and output a second drive signal to the drive circuit after the bus current and/or the phase current of the brushless motor is processed by the signal processing unit, and the drive circuit is configured to control the brushless motor to output a sinusoidal current, so that the brushless motor drives the saw blade to operate in a cutting number of at least 0.9 cuttings per watt hour.

In one example, in the circular saw, the transmission device includes a worm wheel and a worm that are meshed with each other.

In one example, the circular saw further includes a unidirectional conductive element and a switching device. The switching device is connected between the drive circuit and the power supply, and configured to generate a switching signal in response to an operation of a user on the circular saw. And the unidirectional conductive element is connected in parallel with the switching device, and turned on when the switching device is in a switch-off state. And when the unidirectional conductive element is turned on, the sinusoidal current output by the motor is fed back to the power supply by the drive circuit.

In one example, the circular saw further includes a diode D1, configured for feeding back a current of the brushless motor to the power supply via the diode D1.

In one example, the circular saw further includes a diode D1 and a switching device. The switching device is connected between the drive circuit and the power supply, and configured to generate a switching signal in response to an operation of a user on the circular saw. And the diode D1 is connected in parallel with the switching device, and turned on when the switching device is in a switch-off state. And when the diode D1 is turned on, the sinusoidal current output by the brushless motor is fed back to the power supply by the drive circuit.

In one example, in the circular saw, after is processed by the signal processing unit, the second drive signal is output to the drive circuit, so that the brushless motor drives the saw blade to operate in a cutting number within a range from 0.9 to 1.0 cuttings per watt hour.

In one example, in the circular saw, after is processed by the signal processing unit, the second drive signal is output to the drive circuit, so that the brushless motor drives the saw blade to operate in a cutting number within a range from 1.0 to 1.2 cuttings per watt hour.

In one example, in the circular saw, after is processed by the signal processing unit, the second drive signal is output to the drive circuit, so that the brushless motor drives the saw blade to operate in a cutting number within a range from 1.2 to 1.4 cuttings per watt hour. In one example, in the circular saw, after is processed by the signal processing unit, the second drive signal is output to the drive circuit, so that the brushless motor drives the saw blade to operate in a cutting number within a range from 1.4 to 1.6 cuttings per watt hour.

Simultaneously, the present disclosure further provides a circular saw, including: a motor having a stator and a rotor; and a transmission device, operatively coupled with the rotor to drive a saw blade of the circular saw so as to perform a cutting operation on a workpiece; a drive circuit, configured for outputting a first drive signal to control the rotor of the motor to operate; a switching device, configured for generating a switching signal in response to an operation on the circular saw; and a control unit, configured for generating a drive signal to drive the motor in response to the switching signal of the switching device. The control unit includes a signal processing unit. The signal processing unit is configured to collect a bus current and/or a phase current of the motor, and output a second drive signal to the drive circuit after the bus current and/or the phase current of the motor is processed by the signal processing unit, and the drive circuit is configured to control the motor to output a sinusoidal current, so that the motor drives the saw blade to operate in a cutting number of at least 0.9 cuttings per watt hour.

In one example, the circular saw further includes a feedback circuit. The feedback circuit is configured to feed back a current of the motor to the power supply of the circular saw.

In one example, the circular saw further includes a diode D1, configured for feeding back a current of the motor to the power supply of the circular saw via the diode D1.

In one example, the circular saw further includes a unidirectional conductive element; in response to the unidirectional conductive element being turned on, a current output by the motor is fed back to the power supply of the circular saw through the unidirectional conductive element.

In one example, in the circular saw, the phase current and/or the bus current of the motor include any one or combination of the bus current of the motor, the phase current of the motor, and an inter-electrode current of a switching element on the switching circuit.

In one example, in the circular saw, the transmission device includes a worm wheel and a worm that are meshed with each other.

In one example, in the circular saw, after is processed by the signal processing unit, the second drive signal is output to the drive circuit, so that the motor drives the saw blade to operate in a cutting number within a range from 0.9 to 1.0 cuttings per watt hour.

In one example, in the circular saw, after is processed by the signal processing unit, the second drive signal is output to the drive circuit, so that the motor drives the saw blade to operate in a cutting number within a range from 1.0 to 1.2 cuttings per watt hour.

In one example, in the circular saw, after is processed by the signal processing unit, the second drive signal is output to the drive circuit, so that the motor drives the saw blade to operate in a cutting number within a range from 1.2 to 1.4 cuttings per watt hour.

In one example, in the circular saw, after is processed by the signal processing unit, the second drive signal is output to the drive circuit, so that the motor drives the saw blade to operate in a cutting number within a range from 1.4 to 1.6 cuttings per watt hour.

In one example, the motor is configured to be a brushless direct current motor or a permanent magnet synchronous motor.

In one example, the transmission device may further include a deceleration structure. The deceleration structure may include gear structures with different gear ratios, or belt transmission structures with different pulley radii.

The present disclosure further provides a circular saw, including:

a bottom plate; a housing, mounted on the bottom plate; a saw blade cover, connected to the housing; a saw blade shaft, configured for supporting a saw blade in the saw blade cover; a brushless motor, disposed in the housing and including a stator and a rotor; a motor shaft, driven by the rotor of the brushless motor; a transmission device, configured to connect the motor shaft and the saw blade shaft, where the transmission device includes a worm wheel and a worm that are meshed with each other; a drive circuit, including a switching circuit for outputting a first drive signal to control the rotor of the brushless motor to operate; a switching device, disposed on an outer surface of the housing and configured to generate a switching signal in response to an operation of a user on the circular saw; a control unit, including one or one group of controllers for driving the brushless motor according to the first drive signal generated by the drive circuit; and a battery pack, for supplying power to the brushless motor, the drive circuit, and the control unit. The control unit or controller includes a signal processing unit. The signal processing unit is configured to collect a bus current and/or a phase current of the brushless motor, and output a second drive signal to the drive circuit after the bus current and/or the phase current of the brushless motor is processed by the signal processing unit, so that the brushless motor drives the saw blade to recover at least 0.01 wh of energy during each shutdown of the circular saw.

In one example, in the circular saw, the control unit further includes a position estimation unit that is electrically connected to a phase line of the motor and obtains a position of the rotor of the brushless motor by calculating according to a terminal voltage and/or a current on a phase line of the brushless motor and outputs the position of the rotor to the signal processing unit. The signal processing unit generates the second drive signal to drive the rotor of the brushless motor, and the second drive signal is generated according to the position of the rotor of the brushless motor.

In one example, in the circular saw, a position sensor is further provided adjacent to the brushless motor, the control unit or the controller is further electrically connected to the position sensor, and configured to obtain the position of the rotor of the brushless motor according to a signal of the position sensor, and the second drive signal is generated according to the position of the rotor of the brushless motor.

In one example, in the circular saw, the signal processing unit processing the phase current and/or the bus current of the motor includes: according to the phase current and/or the bus current of the motor, generating the second drive signal according to the obtained position of the rotor of the motor to drive the motor, so as to control the motor to output a sinusoidal current. In one example, the signal processing unit processing the phase current and/or the bus current of the motor includes: in response to a signal of the switching device and/or the working data of the battery pack, according to the phase current and/or the bus current of the motor, generating the second drive signal according to the position of the rotor of the motor to drive the motor, so as to control the motor to output a sinusoidal current. The amplitude and/or a direction of the sinusoidal current may be adjusted by the second drive signal. And the working data of the battery pack includes the output current of the battery pack and/or the temperature of the battery pack; the signal of the switching device includes standby, shutdown, deceleration, or energy recovery.

In one example, the circular saw further includes a unidirectional conductive element. The switching device is connected between the drive circuit and the battery pack, the unidirectional conductive element is connected in parallel with the switching device, and a current flows from the drive circuit to the battery pack when the unidirectional conductive element is turned on.

In one example, the circular saw further includes a diode D1, configured for feeding back a current of the brushless motor to the battery pack via the diode D1.

In one example, the circular saw further includes a diode D1, where the diode D1 is connected in parallel with the switching device, and turned on when the switching device is in a switch-off state, so as to feed back a current output by the brushless motor to the battery pack via the diode D1.

Simultaneously, the present disclosure further provides a circular saw, including: a brushless motor having a stator and a rotor; a motor shaft, connected to the rotor of the motor and driven by the rotor of the brushless motor; a saw blade shaft, configured for supporting the rotation of a saw blade to perform a cutting operation on a workpiece; a transmission device, configured for connecting the motor shaft to the saw blade shaft; a drive circuit, configured for output a first drive signal to control the rotor of the brushless motor to operate; a control unit, configured to drive the brushless motor according to the first drive signal generated by the drive circuit; and a power supply, configured to supply power to the brushless motor, the drive circuit, and the control unit. And the control unit includes a signal processing unit. The signal processing unit is configured to collect a bus current and/or a phase current of the brushless motor, and output a second drive signal to the drive circuit after the bus current and/or the phase current of the brushless motor is processed by the signal processing unit, and the drive circuit is configured to control the brushless motor to output a sinusoidal current, so that the brushless motor drives the saw blade to recover at least 0.01 wh of energy during each shutdown of the circular saw.

In one example, in the circular saw, the transmission device includes a worm wheel and a worm that are meshed with each other.

In one example, the circular saw further includes a unidirectional conductive element and a switching device. The switching device is connected between the drive circuit and the power supply, and configured to generate a switching signal in response to an operation of a user on the circular saw. And the unidirectional conductive element is connected in parallel with the switching device, and turned on when the switching device is in a switch-off state. And when the unidirectional conductive element is turned on, the sinusoidal current output by the motor is fed back to the power supply by the drive circuit.

In one example, the circular saw further includes a diode D1, configured for feeding back a current of the brushless motor to the power supply via the diode D1.

In one example, the circular saw further includes a diode D1 and a switching device. The switching device is connected between the drive circuit and the power supply, and configured to generate a switching signal in response to an operation of a user on the circular saw; and the diode D1 is connected in parallel with the switching device, and turned on when the switching device is in a switch-off state. And when the diode D1 is turned on, the sinusoidal current output by the brushless motor is fed back to the power supply by the drive circuit.

Simultaneously, the present disclosure further provides a circular saw, including: a motor having a stator and a rotor; and a transmission device, operatively coupled with the rotor to drive a saw blade of the circular saw to perform a cutting operation on a workpiece; a drive circuit, configured for outputting a first drive signal to control the rotor of the motor to operate; a switching device, configured for generating a switching signal in response to an operation on the circular saw; and a control unit, configured for generating a drive signal to drive the motor in response to the switching signal of the switching device. And the control unit includes a signal processing unit. The signal processing unit is configured to collect a bus current and/or a phase current of the motor, and output a second drive signal to the drive circuit after the bus current and/or the phase current of the motor is processed by the signal processing unit, and the drive circuit is configured to control the motor to output a sinusoidal current, so that the motor drives the saw blade to recover at least 0.01 wh of energy during each shutdown of the circular saw.

In one example, the circular saw further includes a feedback circuit, where the feedback circuit is configured to feed back a current of the motor to the power supply of the circular saw.

In one example, the circular saw further includes a diode D1, configured for feeding back a current of the motor to the power supply of the circular saw via the diode D1.

In one example, the circular saw further includes a unidirectional conductive element. In response to the unidirectional conductive element being turned on, a current output by the motor is fed back to the power supply of the circular saw through the unidirectional conductive element.

In one example, in the circular saw, the phase current and/or the bus current of the motor include any one or combination of the bus current of the motor, the phase current of the motor, and an inter-electrode current of a switching element on the switching circuit.

In one example, in the circular saw, the transmission device includes a worm wheel and a worm that are meshed with each other.

In one example, the motor is configured to be a brushless direct current motor or a permanent magnet synchronous motor.

In one example, the transmission device may further include a deceleration structure. The deceleration structure may include gear structures with different gear ratios, or belt transmission structures with different pulley radii.

According to the disclosure, a signal processing unit processes a phase current and/or a bus current of the motor obtained by sampling to generate a drive signal, and drives the motor according to the drive signal, so that the motor outputs a sinusoidal current. Through the processing of the signal processing unit, the drive signal generated by the present disclosure may control a direction and an amplitude of the sinusoidal current of the motor to feed back a current component generated by the motor to the power supply to charge the power supply, which realizes energy recovery, and controlling the charging current to the power supply during the energy recovery process to be not greater than 50 A to avoid excessive impact on the power supply, so that the power supply is protected, and at least 0.01 wh of energy in each shutdown process is recovered. Through the energy recovery, for the circular saw described in the present disclosure, the power reserve per watt-hour of the power supply may afford the circular saw to complete a number of at least 0.9 cuttings. That is, the power utilization efficiency of the present disclosure is improved by at least ⅕ compared with the existing circular saw. That is to say, under a condition of an identical amount of power reserve of a power supply, effective working time of the circular saw described in the present disclosure may be extended to 1.2 times or more the length of the existing circular saw.

### BRIEF DESCRIPTION OF DRAWINGS

FIG. 1 is a schematic view illustrating an external structure of a circular saw in a first example provided by the present disclosure;

FIG. 2 is a schematic view illustrating a connection relationship of a circular saw in a second example provided by the present disclosure;

FIG. 3 is a structural schematic view illustrating a circular saw in a third example provided by the present disclosure;

FIG. 4 is an architectural block diagram illustrating a circuit system in the first example provided by the present disclosure;

FIG. 5 is an architectural block diagram illustrating a circuit system in the second example provided by the present disclosure;

FIG. 6 is a schematic diagram illustrating a control process of a signal processing unit in a motor control system provided by the present disclosure;

FIG. 7 is an architectural block diagram illustrating a circuit system in the third example provided by the present disclosure; and

FIG. 8 is a test pattern illustrating a current of the motor in an energy recovery process of a circular saw provided by the present disclosure.

### DETAILED DESCRIPTION

The present disclosure will be described below in detail in conjunction with the accompanying drawings and specific examples.

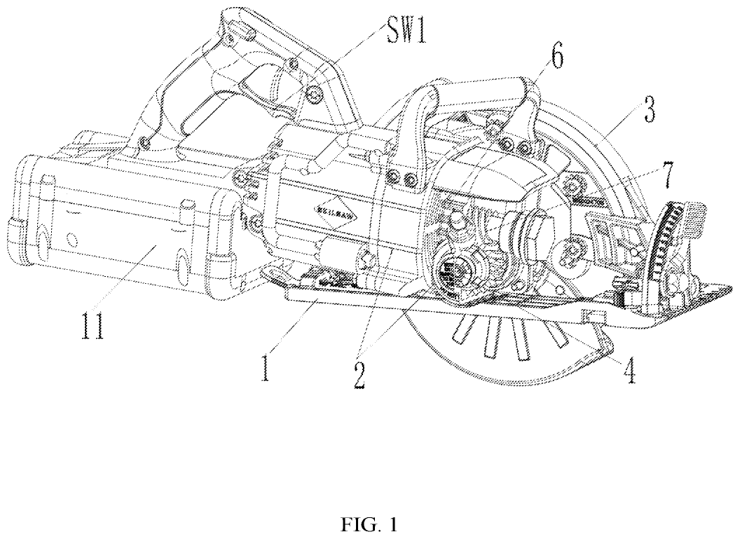

In the first example of the present disclosure, in conjunction with FIG. 1, the present disclosure provides a circular saw, whose specific structure includes: a bottom plate 1; a housing 2, mounted on the bottom plate; a saw blade cover 3, connected to the housing; a saw blade shaft 4, configured to support the rotation of a saw blade in the saw blade cover to cut a workpiece; a motor, disposed in the housing and including a stator and a rotor; a motor shaft 6, driven by the rotor of the motor; and a transmission device 7, configured to connect the motor shaft and the saw blade shaft to transfer a rotational motion of the motor shaft to the saw blade shaft so as to drive the saw blade to operate. In one example, the transmission device may include a deceleration mechanism, such as a worm gear and a worm that are meshed with each other, or a deceleration gearbox. The worm gear-and-the worm or deceleration gearbox may include gear structures with different gear ratios or synchronous belt transmission structures with different radii of synchronous wheels. In one example of the present disclosure, the motor is a brushless motor.

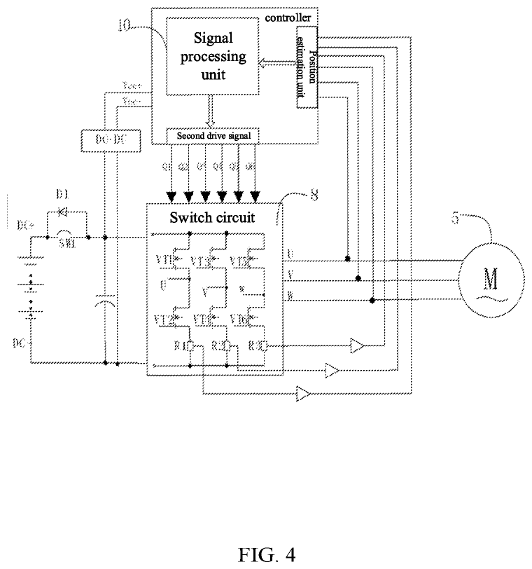

The operation of the circular saw further relies on electronic components mounted on a printed circuit board (PCB), where the PCB is accommodated in the housing 2. With reference to FIG. 4, in one example, the PCB includes a drive circuit, a control unit, and a power supply circuit. The drive circuit includes a switching circuit 8 and may further include a peripheral circuit such as a drive chip, so as to improve a load capacity of the switching circuit 8. In one example, the control unit may be implemented by one controller or a combination of a plurality of controllers, and in another example, the control unit includes a position estimation unit and a signal processing unit 10.

In one example, power supply of the circular saw is arranged to be a battery pack 11. The battery pack supplies power to the motor, the drive circuit, and the signal processing unit via the specific power supply circuit, which specifically corresponds to a DC-DC in the present example.

With reference to FIG. 4, the electronic components of the circular saw further include a switching device SW1 and a diode D1. The switching device is disposed on an outer surface of the housing, and connected to the drive circuit and the battery pack, respectively, and configured to generate an electrical signal to the controller in response to an operation on the circular saw, and in one example, the electrical signal is a switching signal. The diode D1 is connected in parallel with the switching device SW1, and a unidirectional conductive element is turned on when the switching device SW1 is in a switch-off state, so as to feed back a sinusoidal current output by the motor to the power supply via the diode D1.

In FIG. 1, the control unit, the drive circuit, the motor 5, the power supply circuit, and the diode D1 are all enclosed by the housing 2, and are not exposed to a perspective of FIG. 1. And the specific connection relationships may refer to the subsequent description.

Referring to FIG. 4, in one example, the drive circuit is electrically connected to three-phase electrodes U, V and W of the motor 5 so as to drive the motor to operate. In one example, the drive circuit includes a switching circuit 8, and the switching circuit 8 is configured to output a drive signal to the three-phase electrodes of the motor according to the control of the signal processing unit so as to control the rotor of the motor to operate. The drive circuit has an input terminal, an output terminal, and a sampling terminal. As shown in FIG. 4, the switching circuit 8 includes switching elements VT1, VT2, VT3, VT4, VT5 and VT6. The switching elements VT1 to VT6 take field effect transistors as examples, gate terminals of the respective switching elements are used as the input terminal of the drive circuit and electrically connected to a drive signal of the signal processing unit, respectively, and drains or sources of the respective switch elements are electrically connected to the stator of the motor, respectively. In one example of the present disclosure, the drive signal includes six signals of Q1 to Q6. The switching elements VT1 to VT6 sequentially change a respective conduction state according to the drive signal output by the signal processing unit, thereby changing a voltage state that the battery pack 11 applies to a winding of the brushless motor, so as to generate an alternating magnetic field, driving the rotor of the motor to operate.

In one example, in order to rotate the brushless motor, the drive circuit has a plurality of drive states. In a drive state, the stator of the motor generates a magnetic field. The signal processing unit is configured to output a corresponding control signal, according to a rotation position of the rotor of the motor, to the drive circuit to switch the drive state of the drive circuit, so that the magnetic field generated by the stator rotates to drive the rotor to rotate, thereby driving the brushless motor. In one example, the rotational position of the rotor of the motor may be obtained by calculating a phase current of the motor, collected by R1 to R3, via a position estimation unit.

The signal processing unit 10 in the electronic components is configured to drive the drive circuit according to an electrical signal of the switching device SW1 located on the outer surface of the housing. And the signal processing unit includes an input terminal and a drive signal output terminal. The input terminal or the drive signal output terminal may be implemented by special interface hardware, or may merely correspond to a corresponding pin of a chip. The drive signal output terminal is connected to the input terminal of the drive circuit, and the input terminal of the signal processing unit receives the signal of the switching device, the rotation position of the rotor of the motor output by the position estimation unit, and samples of the phase current of the motor. And the signal processing unit is configured to process an operating current of the motor according to the switching signal of the switching device to generate the drive signal. Specifically, in the present example, the signal processing unit is configured to process the phase current of the motor to generate the drive signal. The operating current may also be a bus current or a combination of the bus current and a phase current of the motor. The drive signal is output by the drive signal output terminal to drive the drive circuit to control the motor to output the sinusoidal current so as to drive the saw blade. The drive signal may also be generated by the signal processing unit according to the switching signal of the switching device and/or working data of the battery pack in the circular saw, and the phase current and/or the bus current. The switching circuit drives the motor to operate to output the sinusoidal current according to the drive signal, whereby an amplitude and/or a direction of the sinusoidal current is adjusted according to the drive signal. In one example of the present disclosure, the signal processing unit is configured to collect the bus current and/or the phase current of the motor, and output the drive signal to the drive circuit after the bus current and/or the phase current of the motor is processed by the signal processing unit, so that the brushless motor charges the battery pack with a charging current less than or equal to 50 A. In another example of the present disclosure, the signal processing unit is configured to collect the bus current and/or the phase current of the brushless motor, and output the drive signal to the drive circuit after the bus current and/or the phase current of the brushless motor being further processed by the signal processing unit, so that the brushless motor charges the battery pack with a charging current less than or equal to 50 A when the brushless motor outputs the sinusoidal current.

That is, the drive signal output after is processed by the signal processing unit controls the drive circuit to feed back the current generated on the motor to the power supply via a feedback circuit, so as to charge the power supply, thereby achieving energy recovery. In one example, the drive signal output after is processed by the signal processing unit controls the drive circuit to enable the motor to output the sinusoidal current and feed back the sinusoidal current to the power supply via the feedback circuit to charge the power supply, thereby achieving energy recovery.

In one example, the drive signal output after is processed by the signal processing unit is sent to the drive circuit, and the drive circuit enables the motor to output the current or the sinusoidal current, so that a negative torque generated by the motor is fed back to the power supply via the feedback circuit to charge the power supply, thereby achieving energy recovery. In one example of the present disclosure, as shown in FIGS. 4, 5, and 7, the drive circuit enables the motor to output a current or a sinusoidal current, and enables a current component that makes the motor generate the negative torque to be fed back to the power supply via the diode D1, so as to charge the power supply, thereby achieving energy recovery. Through the energy recovery, the number of cuttings that may be completed by the electric power reserve per watt-hour of the power supply in the circular saw is increased, thereby improving the utilization efficiency of the power supply.

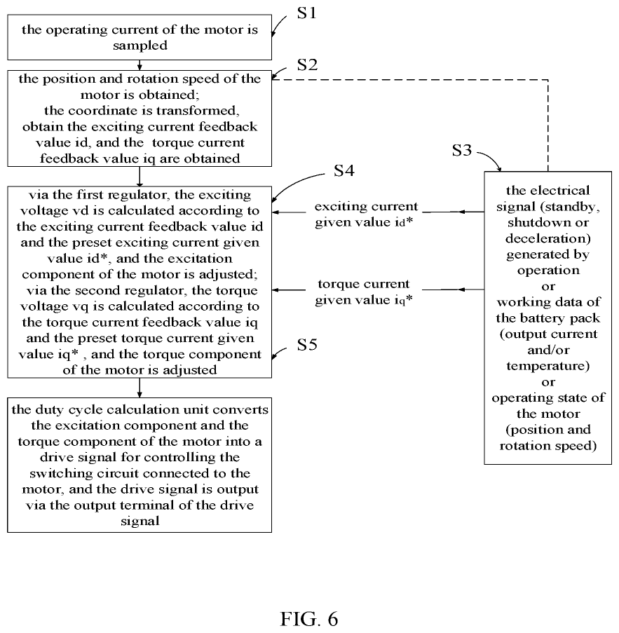

In the following, the signal processing unit shown in FIG. 4 is combined with steps shown in FIG. 6 to describe the detailed steps of the signal processing unit for processing the phase current and/or the bus current of the motor.

Referring to FIG. 6, in step S1, the signal processing unit obtains the phase current of the motor via the input terminal.

In step S2, the position of the motor is obtained by calculating the current via the position estimation unit, and a rotation speed of the motor is calculated, A coordinate transformation of the phase current of the motor is conducted by a coordinate transformation unit, and includes Clark transformation and Park transformation to obtain an exciting current feedback value id and a torque current feedback value iq.

In step S4, a current loop unit is adopted. In one example, as shown in FIG. 6, a first regulator and a second regulator are used to regulate an excitation component of the motor according to the exciting current feedback value id and the preset exciting current given value id*, respectively; a torque component of the motor is adjusted according to the torque current feedback value iq and the preset torque current given value iq*. The preset exciting current given value id* and/or the preset torque current given value iq* are determined by a speed adjusting signal jointly generated by an electric signal generated by an operation on the circular saw, working data of the battery pack, and an operating state of the motor, which are received by the controller in the step S3. In one example, the electrical signal generated by the operation on the circular saw may include standby, shutdown, or deceleration, which may be obtained via an on-off state of the switching device SW1, that is, the switching signal of the switching device SW1; the working data of the battery pack includes the output current of the battery pack and/or temperature of the battery pack; and the operating state of the motor includes a position and rotation speed of the motor.

The two components are adjusted by the current loop unit and then output to a duty cycle calculation unit. The duty cycle calculation unit converts the excitation component and the torque component of the motor into a drive signal for controlling the switching circuit 8 connected to the motor via step S5, and the drive signal is output via the output terminal of the drive signal; where a specific calculation process of the conversion may be implemented by first performing an inverse Park transformation, and then performing SVPWM calculation or SPWM calculation.

The present example specifically aims at the phase current, but the bus current or the combination of the phase current and the bus current may also be similarly processed by the method and steps shown in FIG. 6 by replacing the working current of the motor in FIG. 6 to achieve similar drive signals.

According to the drive signal, on/off of the switching elements in the switching circuit shown by TV1 to TV6 on an upper side of FIG. 4 is controlled to realize power supply to coils of each phase in the motor. Therefore, the motor outputs the sinusoidal current, which drives the motor in the circular saw to operate in accordance with the current direction and amplitude requirements of the operation on the circular saw and the working data of the battery pack.

In one example, the drive signal may be designed as duty cycle data, which controls the drive circuit. In one example, a switching circuit therein controls energizing time of the windings in the motor according to the drive signal, and turns on the winding of the corresponding phase according to the drive signal, so that a regularly changing magnetic field is generated to drive the rotor of motor to operate. In one example, the drive signal may be duty cycle data of the motor. For the duty cycle data, the larger the ratio of conduction time is, the greater the magnetic field strength in the motor is, and the faster the rotor of the motor operates. When the motor operates, due to inductive effect of the winding thereof, the motor outputs the sinusoidal current. Adjusted by the duty cycle data, the amplitude and/or the direction of the sinusoidal current is limited by the switching signal of the switching device SW1 and/or the working data of the battery pack in the power tool. In one example, in a standby state, the signal processing unit generates the drive signal to drive the motor to operate to output sinusoidal current with an amplitude in a standby gear, and in the standby gear, the rotation speed of driving the motor to operate is maintained at a low speed relative to the working state; in a shutdown or deceleration state, the signal processing unit generates the drive signal to drive the motor to operate to output the sinusoidal current to the battery pack. When the working data of the battery pack is abnormal, or when a control signal for the power tool received by the signal processing unit is a shutdown signal or deceleration signal, the signal processing unit generates the drive signal to drive the motor to operate to output sinusoidal current with a decreasing amplitude, until the abnormal working data of the battery pack is eliminated. The abnormal working data of the battery pack includes excessively large output current of the battery pack and/or excessively high temperature of the battery pack.

In one example, in the signal processing unit, the above-mentioned control may correspond to the above-mentioned speed adjusting requirements according to the working data of the battery pack in the power tool and/or the electric signal received by a control interface of the motor by setting the excitation current given value id* and the torque current given value iq*, and limiting the current of the motor, shutdown, deceleration, energy recovery, no-load and low-speed standby, and so forth are included. The specific setting steps are performed as follows to achieve control of the amplitude and flow direction of the sinusoidal current output by the motor.

In one example, when the signal processing unit acquires that the power tool enters the standby state, the signal processing unit generates the drive signal to drive the motor to operate to output the sinusoidal current with the amplitude value in the standby gear. A plurality of manners to enter the standby state are provided, for example, the switching device SW1 may be triggered to enter the standby state by manual set, or a short period of time immediately after triggering the working state is in the standby state by default, and then comes the working state. In one example, in the standby gear, an absolute value of the excitation current given value id* is limited, or an absolute value of the torque current value given iq* is also limited, and the drive signal is generated after conversion by the duty cycle calculation unit to control the rotation speed at which the amplitude of the sinusoidal current in the standby gear drives the motor to operate, thereby being controlled to be less than the rotation speed at which the amplitude of the sinusoidal current in the working state drives the motor to operate.

When the signal processing unit receives the abnormal working data of the battery pack in the power tool received by the signal processing unit, including the excessively high temperature or excessively large current, or when the signal processing unit receives that the power tool enters the shutdown or deceleration state, the signal processing unit generates the drive signal to drive the motor to operate to output the sinusoidal current with a decreasing amplitude, until the abnormal working data of the battery pack is eliminated. In one example, driving the amplitude of the sinusoidal current to decrease may be achieved by decreasing the torque current feedback value iq and/or the torque current given value iq*; or by setting a excitation current given value id* vector to be negative. The magnetic field of the motor may be counteracted in the algorithm by such setting, thereby reducing the power supply of the motor, such as the current output by the battery pack, thereby effectively adjusting the power consumption of the power tool. The direct regulation for the current in the circuit is difficult to be achieved in the field of conventional power tools.

When the signal processing unit receives that the power tool enters the shutdown or the deceleration state, the signal processing unit generates the drive signal to drive the motor to operate to output the sinusoidal current to the battery pack. Such an effect can be specifically controlled by setting the torque current given value iq* vector to be negative, and the excitation current given value i* may also be set to 0 at the same time. As a result, the torque of the motor is counteracted in the algorithm, thereby reducing driving capability of the motor, and effectively reducing the operating speed of the motor. At the same time, the switch triggered by a shutdown or deceleration command, SW1 in FIG. 4 may also be placed in the switch-off state while the torque current given value iq* vector is set to negative. Therefore, the current of the motor will pass through the unidirectional conductive element, for example, the diode D1 in FIG. 4 feeds back the negative current to the battery pack to charge the battery pack.

During the charging process, the signal processing unit outputs the drive signal to control the drive circuit, and the drive circuit controls the sinusoidal current output by the motor, and then magnitude of the negative torque generated by the motor from the sinusoidal current is controlled. Therefore, when the generated negative torque current component of the motor is fed back to the power supply via the diode D1, the magnitude of the current for charging the power supply may be limited to a current range in which the battery is effectively charged, thereby protecting the battery and achieving energy recovery.

In one example, the signal processing unit may generate a corresponding drive signal by controlling the torque current feedback value iq and/or the torque current given value iq*, and the drive signal controls the switching circuit to drive the motor to operate, and then the amplitude and flow direction of the sinusoidal current output by the motor are controlled so that the converted charging current flows to the battery pack within an acceptable range of the battery pack, thereby achieving effective charging and protecting the battery pack. For the charging current:

when an impact time of the charging current does not exceed 200 ms, a maximum impact current (charging current) may be controlled at 6c or below;

when the impact time of the charging current does not exceed 1 ms, the maximum impact current (charging current) may be controlled at 5c or below; and

when the impact time of the charging current reaches 1 s or more, the maximum impact current (charging current) may be controlled at 4c or below.

The relationship between the magnitude of the maximum impact current and the number p of the battery packs connected in parallel is: number (p)×capacity (Ah) of each battery pack=amperage (A) of the maximum impact current. For example, for a number 1p of battery packs with a capacity of 2.5 Ah, the current corresponding to the maximum impact current 6c is 15 A; for a number 2p of battery packs with a capacity of 2.5 Ah, and the current corresponding to the maximum impact current 6c is 30 A.

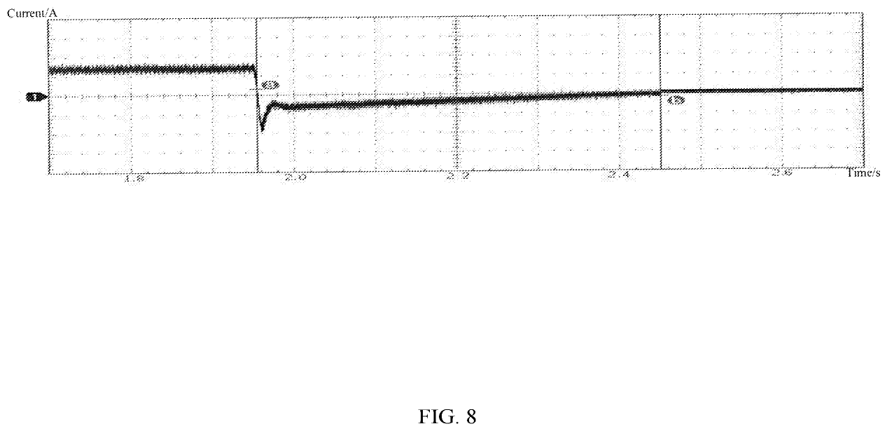

Referring to FIG. 8, during the energy recovery process, the circular saw having the worm gear and worm structure as the transmission device tests out the current data of the motor indicated by reference numeral 1. The impact process of the charging current is between two points a and b, the impact time of the charging current is within 496 ms, and the maximum impact current is 4.8 A. Taking a 48V DC power supply as an example, the energy recovered by the present charging current corresponds to 0.02 wh.

The above-mentioned manners may actually be applied to any power tool to achieve control for the sinusoidal current output by the operation of the motor inside the power tool, according to the different working states of the motor, such as standby, deceleration, shutdown, and energy recovery, and through the processing for the phase current and/or the bus current of the motor by the signal processing unit. In one example, controlling the direction and amplitude of the sinusoidal current is included. In one example, the above-mentioned manners are applied to the circular saw. Because the excitation component and torque component of the motor is adjusted by the signal processing unit, the energy consumption level may be dynamically adjusted according to the state of the power tool, and the energy of the motor may be recovered when needed. Therefore, the utilization rate of electric power of the power tools described in the present disclosure has been significantly improved. In one example, the circular saw may recover at least 0.01 wh of energy each time through power control or energy recovery, and utilize the capacity per watt-hour of the battery pack to achieve a number of more than 0.9 cuttings during the cutting process. At the same time, since the charging current to the power supply during the control of energy recovery is not greater than 50 A, excessive impact on the power supply is avoided and the power supply is protected.

Referring to a lower side of FIG. 4, the above-mentioned manners, specifically, merely take collecting the phase current of the motor as an example. The collection of the phase current of the motor may be realized by resistors R1 to R3 connected in series on three bridge arms formed by the switching elements VT1 to VT6 in the switching circuit shown in the lower side of FIG. 4. The resistors R1 to R3 connected in series on the three bridge arms convert the phase current of the motor into a sampled voltage signal, and the sampled voltage signal is amplified via an amplifier, and input to the controller to realize the collection of the phase current of the motor.

It should be noted that the current signal collected by the controller may include, the phase current in the present example, any one, any number, any combination, or any number of combinations of the inter-electrode current of the switching elements on the switching circuit connected to the motor and the bus current of the motor. Certainly, those skilled in the art may also perform similar processing directly through a sampling resistor connected in series to the bus connected to a lower arm of the switching circuit 8, or directly analyze the inter-electrode current of the switching element such as VT2 through an algorithm to match correction functions based on characteristics of the component, or the above-mentioned methods may be comprehensively applied, where operation condition of the motor may be obtained by the same analysis. The sampling of the bus current of the motor will be analyzed in the next example.

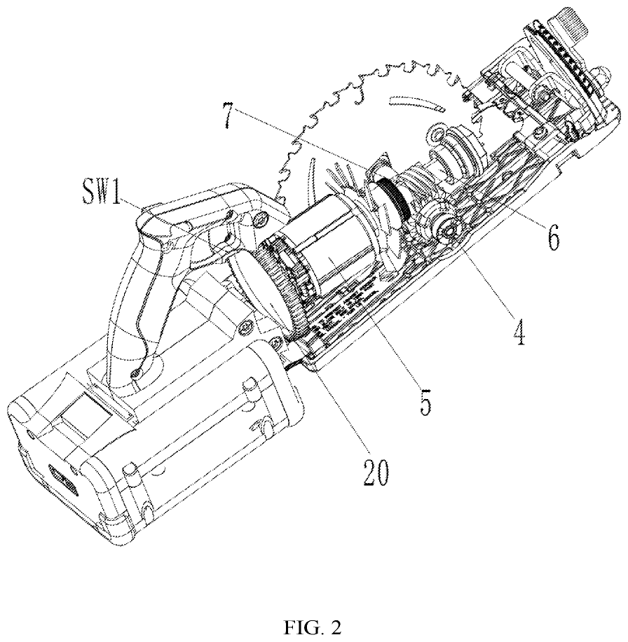

In the second example of the present disclosure, in conjunction with FIG. 2, the present disclosure further provides a circular saw, whose specific structure includes:

a motor 5, having a stator and a rotor; a motor shaft 6, driven by the rotor of the motor; a saw blade shaft 4, configured for supporting a saw blade to rotate to perform a cutting operation on a workpiece; and a transmission device, configured for connecting the motor shaft to the saw blade shaft.

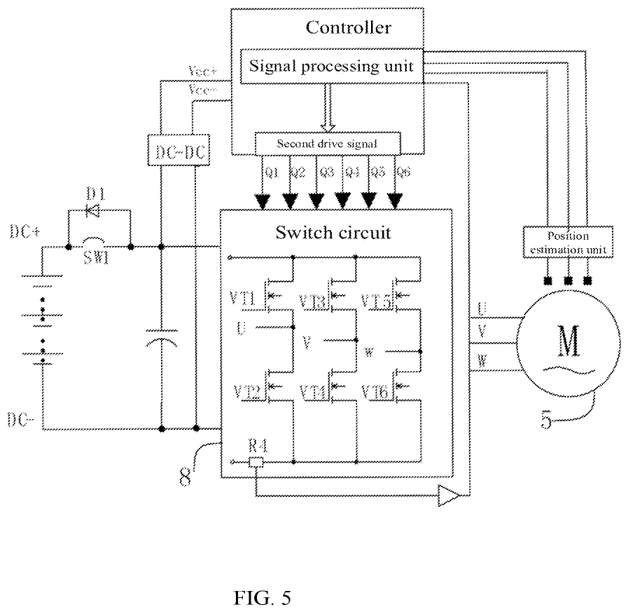

The operation of the circular saw further relies on electronic components mounted on a printed circuit board (PCB), where the PCB is mounted behind the motor 5. With reference to FIG. 5, the PCB 20 in the present example may include a switching circuit 8, a controller, a position sensor and a power circuit. The controller includes a signal processing unit 10. The position sensor is mounted on the stator of the motor 5 and configured to sense a position of the rotor and output a position signal of the rotor of the motor to the controller.

The power supply of the circular saw may be arranged to be a battery pack 11 or other power supply device. Through a specific power supply circuit specifically corresponding to a DC-DC in the present example, the power supply supplies power to the motor, the switching circuit, and the signal processing unit. The controller or the signal processing unit may be implemented by selecting an appropriate control chip according to the precision and response time required for the control of the circular saw. The control chip includes a Microcontroller Unit (MCU), an Advanced RISC Machines (ARM) chip, a Digital Signal Processor (DSP), and the like.

With reference to FIG. 5, the PCB of the circular saw is further connected to a switching device SW1 and a unidirectional conductive element D1. The switching device is connected to the drive circuit and the power supply, and is configured to generate a corresponding signal to the controller in response to an operation on the circular saw. In one example, the unidirectional conductive element D1 may be arranged to be a diode, a thyristor, and the like. Taking the diode as an example, the diode is connected in parallel with the switching device SW1. The unidirectional conductive element is turned on when the switching device SW1 is in a switch-off state, so as to feed back the sinusoidal current output by the motor to the power supply via the diode D1. The implementation of the thyristor is similar to that of the diode, as long as the current between the pins in the thyristor used for unidirectional conduction is ensured to be fed back to the power supply.

With reference to FIG. 5, a specific manner in which the switching circuit drives the motor 5 is similar to that of the first example, and details are not described herein. The difference between the present example and the first example is as follows, the rotation position of the rotor of the motor may be directly obtained through the position sensor and transmitted to the controller. Therefore, a position estimation unit is not necessary to be provided in the controller in the present example. The controller generates the drive signal according to the position of the rotor of the motor obtained by the position sensor and the bus current obtained by a sampling resistor R4, and sends the drive signal to the drive circuit to enable the drive circuit switch to the drive state, thereby rotating the magnetic field generated by the stator to drive the rotor to rotate, so that the brushless motor is driven. Thereby, the motor outputs the sinusoidal current to drive the saw blade. The drive signal may also be generated in a manner similar to that of the first example by the signal processing unit according to the switching signal of the switching device and/or the working data of the battery pack in the power tool, and the bus current obtained by sampling. The detailed steps of the signal processing unit processing the bus current of the motor to generate the drive signal, and the controlling the amplitude and/or the flow direction of the sinusoidal current by the drive signal are similar to those in the previous example. When the bus current of the motor is processed to generate the drive signal, the bus current obtained by sampling is used as the working current of the motor, and the processing steps may refer to FIG. 6. The difference between the present example and the first example is only the step of identifying the position and the rotation speed of the motor, which may be implemented by directly acquiring the data of the position sensor in the present example through the controller.

The above-mentioned manners may achieve control for the sinusoidal current, including the flow direction and amplitude thereof, output by the operation of the motor inside the power tool, according to the different working states of the motor, such as standby, deceleration, shutdown, and energy recovery, and through the processing for the phase current and/or the bus current of the motor by the signal processing unit. In one example, the above-mentioned manners are applied to the circular saw. Because the excitation component and torque component of the motor is adjusted by the signal processing unit, the energy consumption level may be dynamically adjusted according to the state of the circular saws, and in the process of deceleration and shutdown, the current is introduced to the power supply via the unidirectional switching element to recover energy of the motor. In one example, since the signal processing unit outputs the drive signal to control the drive circuit, the sinusoidal current output by the motor is controlled via the drive circuit, thereby controlling the magnitude of the current with the negative torque generated by the sinusoidal current, and realizing the control of the amplitude and direction of the current of the motor. The present disclosure may control the current introduced to the power supply to be within the effective charging current range of 50 A, and ranges of 0 A to 20 A, 20 A to 35 A, 35 A to 50 A may be selected to ensure charging efficiency and protect the power supply.

Therefore, the utilization rate of electric power of the circular saw described in the present disclosure has been significantly improved. In one example, through the power control or energy recovery, the capacity per watt-hour of the battery pack of the circular saw described in the present disclosure achieves a number of cuttings of more than 0.9 cuttings, and the charging current to the power supply is ensured to be equal to or less than 50 A during each recovery process, so that excessive impact on the power supply is avoided, and the power supply is protected. Compared to the current number of cuttings of 0.8 cuttings per watt-hour of the circular saw, the present example improves the working capacity of the circular saw by 20%. That is to say, with the power supply of the same specification, the circular saw in the present example may complete an additional 20% of cutting operations. And the increase in efficiency is still considerable. The number of cuttings obtained here, such as at least 0.9 to 1.0 cuttings per watt-hour, 1.0 to 1.2 cuttings per watt-hour, 1.2 to 1.4 cuttings per watt-hour, and 1.4 to 1.6 cuttings per watt-hour, are obtained by cutting pine wood, and when the pine wood is cut, a size of a cutting surface is 40 mm×200 mm.

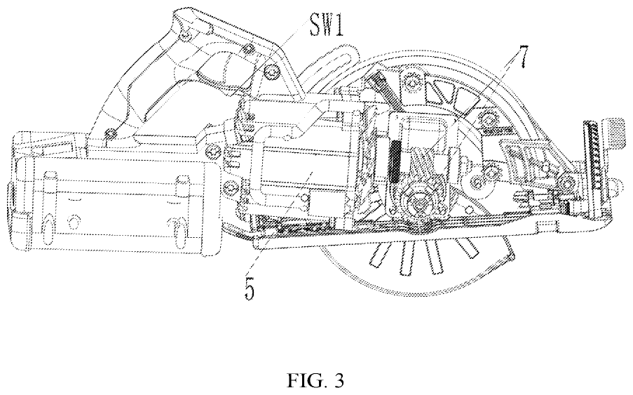

In a third example of the present disclosure, in conjunction with FIG. 3, the present disclosure further provides a hand-held power tool, whose specific structure includes:

a motor 5 having a stator and a rotor; a transmission device 7, operatively coupled to the rotor and configured to transmit a rotary motion of the rotor of the motor to a tool accessory of the hand-held power tool, so as to drive the tool accessory to operate.

The tool accessory here includes, but is not limited to, a drill bit of an electric drill, an abrasive disc of an angle grinder, a cutter lifting mechanism of a reciprocating saw, a saw stripe, a saw blade of a circular saw, a sponge or a polishing disc of a polishing machine, a screw head of a screwdriver, a spiral groove of a spanner, an impact mechanism, a stirring rod of a mixer, etc. Therefore, the power tool described in the present example may correspond to the circular saw, the electric drill, the angle grinder, the reciprocating saw, the polishing machine, the screwdriver, the spanner, the mixer, etc.

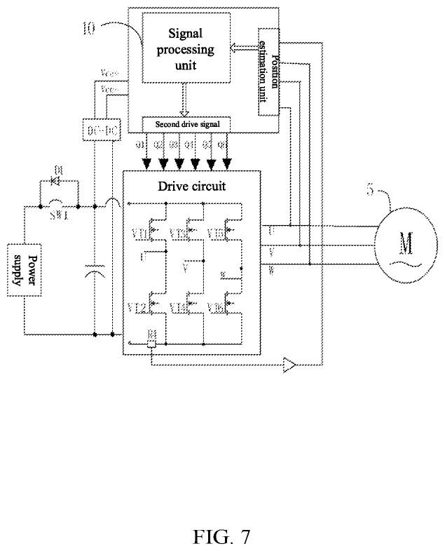

The operation of the hand-held power tool further relies on electronic components mounted on a printed circuit board (PCB), where the PCB may be disposed behind the motor 5. In one example, with reference to FIG. 7, a drive circuit, a controller, and a power supply circuit are included. The controller includes a position estimation unit and a signal processing unit 10.

The power supply of the hand-held power tool supplies power to the motor, the drive circuit, and the signal processing unit via the specific power supply circuit. In the present example, the power supply specifically corresponds to a DC-DC, and may include a power chip and peripheral circuits thereof.

With reference to FIG. 7, the electronic components of the hand-held power tool further include a switching device SW1 and a diode D1. The switching device is connected to the drive circuit and the power supply, and configured to generate an electrical signal to the controller in response to an operation on the hand-held power tool by the user. The diode D1 is connected in parallel with the switching device SW1. A positive electrode of the diode D1 is connected to the drive circuit and a negative electrode of the diode D1 is connected to the power supply. The diode D1 is turned on when the switching device SW1 is in a switch-off state, and feeds back a sinusoidal current output by the motor to the power supply.

With reference to FIG. 7, a manner in which the drive circuit drives the motor 5 to operate is similar to that of the above examples, and details are not described herein again. The difference between the present example and the above examples is that in the present example, the rotation position of the rotor of the motor based on which the signal processing unit generates the drive signal is specifically calculated and obtained by the position estimation unit through the bus current of the motor collected by the resistor R4 on the bus of the drive circuit.

The calculation of the position and the speed of the motor by the position estimation unit may be realized by the following steps.

In step B1, the zero-crossing period of the working current of the motor is locked, and a frequency f of a working current of the motor is calculated; where the working current, here specifically, refers to the bus current of the motor collected by the resistor R4 of the bus of the drive circuit; certainly, the working current of the motor may further include a phase current and/or a bus current and combinations thereof of the motor collected in the above examples, and the processing process is similar;

In step B2, the rotation speed of the motor is calculated by a function of n=60 f/P; where P is a number of electrode pairs of the motor;

In step B3, a position of the motor, which is equal to 1/s ωdt is obtained by integration; where s is a number of sampling points of the motor; and co is an angular frequency corresponding to the frequency f of the working current of the motor.

Different from the traditional method of first calculating a position of the motor and then obtaining a speed of the motor by differentiating the position, calculating the position and the speed of the motor by the above manners may avoid a huge calculation amount brought by the differentiation, saving overhead of the system and improving the calculation efficiency.

The controller generates the drive signal according to the position of the rotor of the motor calculated by the position estimation unit and the bus current obtained by the sampling resistor R4, and sends the drive signal to the drive circuit to enable the drive circuit switch to the drive state, thereby rotating the magnetic field generated by the stator to drive the rotor to rotate, so that the brushless motor is driven. Thereby, the motor outputs the sinusoidal current to drive the saw blade. The drive signal may also be generated in a manner similar to that of the first example by the signal processing unit according to the signal of the switching device SW1 and/or the working data of the battery pack in the power tool, and the bus current obtained by sampling. The detailed steps of the signal processing unit processing the bus current of the motor to generate the drive signal, and the controlling the amplitude and/or the flow direction of the sinusoidal current by the drive signal are similar to those in the above examples. When the drive signal is generated by processing the bus current of the motor, the bus current obtained by sampling is used as the working current of the motor, and the corresponding processing steps may also refer to FIG. 6.

Therefore, according to different working states of the motor, including standby, deceleration, shutdown, and energy recovery, the signal processing unit may process the phase current and/or the bus current of the motor to output the drive signal to control the drive circuit, and the sinusoidal current output by the motor is controlled by the drive circuit, thereby controlling the magnitude of the negative torque generated by the motor due to the sinusoidal current. Thereby, the sinusoidal current output by the operation of the motor in the power tool is controlled. When the negative torque current component generated by the motor is fed back to the power supply via the diode D1, the flow direction and the amplitude of the charging current to the power supply are limited, thereby realizing energy recovery and protection of the power supply during energy recovery. In one example, through the adjustment on the excitation component and torque component of the motor by the signal processing unit, the energy consumption level may be dynamically adjusted according to the state of the power tool, and in the process of deceleration and shutdown, the current is introduced to the power supply via the unidirectional conductive element similar to the diode D1. In the case of using a worm gear and a worm that are meshed with each other as the transmission device 7, the energy recovered each time the current is introduced to the power supply is more than 0.01 wh. Therefore, the utilization rate of electric power of the power tool described in the present disclosure has been significantly improved. In one example, through power control or energy recovery, the power tool described in the present disclosure may increase the operating capacity by an additional 20%, when equipped with a power supply of an identical specification, that is, under an identical load condition, a tool life is extended to 1.2 times the length of the original.

The above illustrates and describes basic principles, main features and advantages of the present disclosure. It is to be understood by those skilled in the art that the above examples do not limit the present disclosure in any form, and all solutions obtained by means of equivalent substitution or equivalent transformation fall within the protection scope of the present disclosure.

The present disclosure provides a circular saw. By optimizing a processing for the phase current and/or the bus current of the motor, the current of the motor in the circular saw may be independently adjusted, and the electric energy generated by the motor is fed back to the power supply to optimize the utilization efficiency of the power supply, making the power consumption characteristics of circular saws and other power tools better.

What is claimed is:

1. A circular saw, comprising:
a bottom plate;
a housing, mounted on the bottom plate;
a saw blade cover, connected to the housing;
a saw blade shaft, configured for supporting a saw blade in the saw blade cover;
a brushless motor, disposed in the housing and comprising a stator and a rotor;
a motor shaft, configured to be driven by the rotor of the brushless motor;
a transmission device, configured for connecting the motor shaft and the saw blade shaft, wherein the transmission device comprises a worm wheel and a worm that are meshed with each other;
a drive circuit, comprising a switching circuit, wherein the switching circuit is configured to output a first drive signal to control the rotor of the brushless motor to operate;
a switching device, disposed on an outer surface of the housing and configured to generate a switching signal in response to an operation of a user on the circular saw;
a control unit, configured to drive the brushless motor according to the first drive signal generated by the drive circuit; and
a battery pack, configured to supply power to the brushless motor, the drive circuit, and the control unit;
wherein the control unit comprises a signal processing unit, the signal process unit is configured to collect a bus current and/or a phase current of the brushless motor and output a second drive signal to the drive circuit after the bus current and/or the phase current of the brushless motor is processed by the signal processing unit, so that the brushless motor charges the battery pack with a charging current less than or equal to 50 A.

2. The circular saw of claim 1, wherein the control unit further comprises a position estimation unit, the position estimation unit is configured to obtain a position of the rotor of the brushless motor according to a terminal voltage and/or a current on a phase line of the brushless motor, and the second drive signal is generated according to the position of the rotor of the brushless motor.

3. The circular saw of claim 1, wherein a position sensor is further provided adjacent to the brushless motor, and the control unit is further electrically connected to the position sensor, and configured to obtain a position of the rotor of the brushless motor according to a signal of the position sensor, and the second drive signal is generated according to the position of the rotor of the brushless motor.

4. The circular saw of claim 1, further comprising a unidirectional conductive element, wherein the switching device is connected between the drive circuit and the battery pack, the unidirectional conductive element is connected in parallel with the switching device, and a current flows from the drive circuit to the battery pack in response to the unidirectional conductive element being turned on.

5. The circular saw of claim 1, further comprising a diode, configured for feeding back a current of the brushless motor to the battery pack via the diode.

6. The circular saw of claim 1, further comprising a diode, wherein the diode is connected in parallel with the switching device, and is turned on in response to the switching device being in a switch-off state, so as to feed back a current output by the brushless motor to the battery pack via the diode.

7. The circular saw of claim 1, wherein after is processed by the signal processing unit, the second drive signal is output to the drive circuit, so that the brushless motor charges the battery pack with a charging current within a range from 35 A to 50 A.

8. The circular saw of claim 1, wherein after is processed by the signal processing unit, the second drive signal is output to the drive circuit, so that the brushless motor charges the battery pack with a charging current within a range from 20 A to 35 A.

9. The circular saw of claim 1, wherein after is processed by the signal processing unit, the second drive signal is output to the drive circuit, so that the brushless motor charges the battery pack with a charging current within a range from 0 A to 20 A.

10. A circular saw, comprising:
a brushless motor, comprising a stator and a rotor;
a motor shaft, configured to be driven by the rotor of the brushless motor;
a saw blade shaft, configured for supporting a saw blade to perform a cutting operation on a workpiece;
a transmission device, configured to connect the motor shaft to the saw blade shaft;
a drive circuit, configured to output a first drive signal to control the rotor of the brushless motor to operate;
a control unit, configured to drive the brushless motor according to the first drive signal generated by the drive circuit; and
a power supply, configured to supply power to the brushless motor, the drive circuit, and the control unit;
wherein the control unit comprises a signal processing unit, the signal process unit is configured to collect a bus current and/or a phase current of the brushless motor and output a second drive signal to the drive circuit after the bus current and/or the phase current of the brushless motor is processed by the signal processing unit, and the drive circuit is configured to control the brushless motor to output a sinusoidal current, so that the brushless motor charges the power supply with a charging current less than or equal to 50 A.

11. The circular saw of claim 10, wherein the transmission device comprises a worm wheel and a worm that are meshed with each other.

12. The circular saw of claim 10, further comprising a diode, configured for feeding back a current of the brushless motor to the power supply via the diode

13. The circular saw of claim 10, further comprising a diode and a switching device;
wherein the switching device is connected between the drive circuit and the power supply, and configured to generate a switching signal in response to an operation of a user on the circular saw;
wherein the diode is connected in parallel with the switching device, and turned on in response to the switching device being in a switch-off state, and in response to the diode being turned on, the sinusoidal current output by the brushless motor is fed back to the power supply by the drive circuit.

14. The circular saw of claim 10, wherein after is processed by the signal processing unit, the second drive signal is output to the drive circuit, so that the brushless motor charges the power supply with a charging current within a range from 35 A to 50 A.

15. The circular saw of claim 10, wherein after is processed by the signal processing unit, the second drive signal is output to the drive circuit, so that the brushless motor charges the power supply with a charging current within a range from 20 A to 35 A.

16. The circular saw of claim 10, wherein after is processed by the signal processing unit, the second drive signal is output to the drive circuit, so that the brushless motor charges the power supply with a charging current within a range from 0 A to 20 A.

17. A circular saw, comprising:
a motor, comprising a stator and a rotor;
a transmission device, operatively coupled to the rotor, and configured to drive a saw blade of the circular saw so as to perform a cutting operation on a workpiece;
a drive circuit, configured to output a first drive signal to control the rotor of the motor to operate; and
a control unit, configured to drive the motor according to the first drive signal generated by the drive circuit;
wherein the control unit comprises a signal processing unit, the signal processing unit is configured to collect a bus current and/or a phase current of the motor and output a second drive signal to the drive circuit after the bus current and/or the phase current of the motor is processed by the signal processing unit, and the drive circuit is configured to control the motor to output a sinusoidal current, so that the motor charges a power supply of the circular saw with a charging current less than or equal to 50 A.

18. The circular saw of claim 17, further comprising a feedback circuit, wherein the feedback circuit is configured to feed back a current of the motor to the power supply of the circular saw.

19. The circular saw of claim 17, further comprising a diode, configured for feeding back a current of the motor to the power supply of the circular saw via the diode.

20. The circular saw of claim 17, further comprising a unidirectional conductive element; in response to the unidirectional conductive element being turned on, a current output by the motor is fed back to the power supply of the circular saw through the unidirectional conductive element.
